(19) United States
(12) Patent Application Publication
(10) Pub. No.: US 2025/0013696 A1
(43) Pub. Date: Jan. 9, 2025

(54) SYSTEMS AND METHODS FOR DETECTING SOURCES OF PIRATED MEDIA IN A NETWORK

(71) Applicant: OPSEC ONLINE LIMITED, Washington (GB)

(72) Inventors: Oleg POLISHCHUK, Chevy Chase, MD (US); Andrigo Spall GOMES, Malmö (SE)

(21) Appl. No.: 18/712,616

(22) PCT Filed: Nov. 30, 2022
(86) PCT No.: PCT/US2022/051398

§ 371 Date: May 22, 2024

Related U.S. Application Data
(60) Provisional application No. 63/284,244, filed on Nov. 30, 2021.

(51) Int. Cl. G06F 16/951; G06F 16/909; G06F 16/955; G06F 40/58

(52) U.S. Cl. CPC G06F 16/951; G06F 16/909; G06F 16/9558; G06F 40/58

(57) ABSTRACT

Exemplary embodiments of the present disclosure relate to systems, methods, and non-transitory computer-readable media for detecting, analyzing and remediating pirated content accessible via a network.

### RELATED APPLICATIONS

This application claims the benefit of and priority to U.S. Provisional Application No. 63/284,244, filed on Nov. 30, 2021, the entire contents of which are incorporated herein by reference.

### BACKGROUND

An overwhelming amount of digital content is accessible over networked environments, such as the Internet. This content is spread across multiple data channels and/or sources, and more and more content is being made available daily. Often the owners of the digital content have intellectual property rights, such as copyrights, in the digital content. While distribution and use of the digital content that is accessible in a network may be authorized by the owner, there are instances where such digital content is made available or pirated by unauthorized sources.

### SUMMARY

Embodiments of the present disclosure enable searching for pirated content in a network throughout the world, while providing local customizations that can be learned by embodiments of the present disclosure to mimic consumer behavior in various countries and languages.

In accordance with embodiments of the present disclosure, systems, methods, and non-transitory computer-readable media are disclosed. The computer-readable media can store instructions for one or more computer-readable media storing instructions for detecting and remediating pirated content accessible via a network. A processor can be programmed to execute the instructions to implement a method that includes generating a query template that includes parameters based on instances of a title associated with content to be searched and keywords; generating a set of queries based on the query template; and generating sets of country-specific queries from the set of queries. The method implemented upon execution of the instructions by the processor can also include transmitting the set of country-specific queries to proxy servers located in countries for which the sets of country-specific sets of queries were generated to execute the queries in search engine mirror sites in the countries; determining whether hyperlinks in search results corresponding to execution of the sets of country-specific queries provide access to pirated content; and initiating delisting of the search results that are determined to provide access to the pirated content.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

In the drawings, like reference numerals refer to like parts throughout the various views of the non-limiting and non-exhaustive embodiments.

FIG. 1 is a block diagram of an exemplary pirated content detection, analysis, and remediation system for detecting, analyzing, and facilitating the removal of pirated content in a networked environment in accordance with embodiments of the present disclosure.

FIG. 2 is a block diagram of an exemplary computing device in accordance with embodiments of the present disclosure.

FIG. 3 is an exemplary networked environment for detecting, analyzing, and facilitating the delisting of pirated content indexed by Internet search engines in accordance with embodiments of the present disclosure.

FIG. 4 is a flowchart illustrating an exemplary process for detecting, analyzing, and facilitating the delisting of pirated content indexed by Internet search engines in accordance with embodiments of the present disclosure using the pirated content detection, analysis, and remediation system in accordance with the present disclosure.

FIG. 5 is a flowchart illustrating an exemplary process for generating an approved domain list in accordance with embodiments of the present disclosure.

FIG. 6 is a flowchart illustrating an exemplary delisting verification process in accordance with embodiments of the present disclosure.

FIG. 7 depicts an example query template in accordance with embodiments of the present disclosure.

FIG. 8 is a graphical user interface that illustrates a search volume analysis that can be performed in accordance with embodiments of the present disclosure.

FIG. 9 is a graphical user interface that illustrates a piracy search volume analysis that can be performed in accordance with embodiments of the present disclosure.

FIG. 10 is a graphical user interface that illustrates a domain rank analysis that can be performed in accordance with embodiments of the present disclosure.

FIG. 11 is another graphical user interface that illustrates a domain rank analysis that can be performed in accordance with embodiments of the present disclosure.

FIG. 12 is another graphical user interface that illustrates a domain rank analysis that can be performed in accordance with embodiments of the present disclosure.

### DETAILED DESCRIPTION

Embodiments of the present disclosure relate to systems, methods, and non-transitory computer-readable media for detecting, analyzing, and removing pirated digital content from networked environments. Embodiments of present disclosure enable searching for pirated content throughout the world, but with local customizations that can be learned by embodiments of the present disclosure to mimic consumer behavior in various countries and languages.

Embodiments of the present disclosure can leverage search engines and mirror sites for search engines in various countries to search for, detect, and identify pirated content that has been indexed by the search engines and/or the mirror sites for the search engines in the various countries using automatically generated queries that have been optimized for each country's search engine and/or mirror site for the search engines in the various countries. This approach can provide a comprehensive and effective tool for finding pirated content being distributed over the Internet in the various countries, assessing the likelihood that the pirated content will be accessed diverting user traffic away from the authorized sources for the content, and for removing the uniform resource locators (URLs) associated with the pirated content from the indexes of the search engines and/or the mirror sites for the search engines.

Embodiments of the present disclosure result in more complete, efficient data retrieval, and more actionable data to decrease the accessibility and/or availability of pirated content on the Internet. Embodiments of the present disclosure can detect pirated content as it would be observed by local consumers all over the world, and then can have the pirated content taken down. In this regard, exemplary embodiments of the present disclosure provide for an efficient and effective tool for detecting, analyzing, and acting upon a growing number of pirated content online.

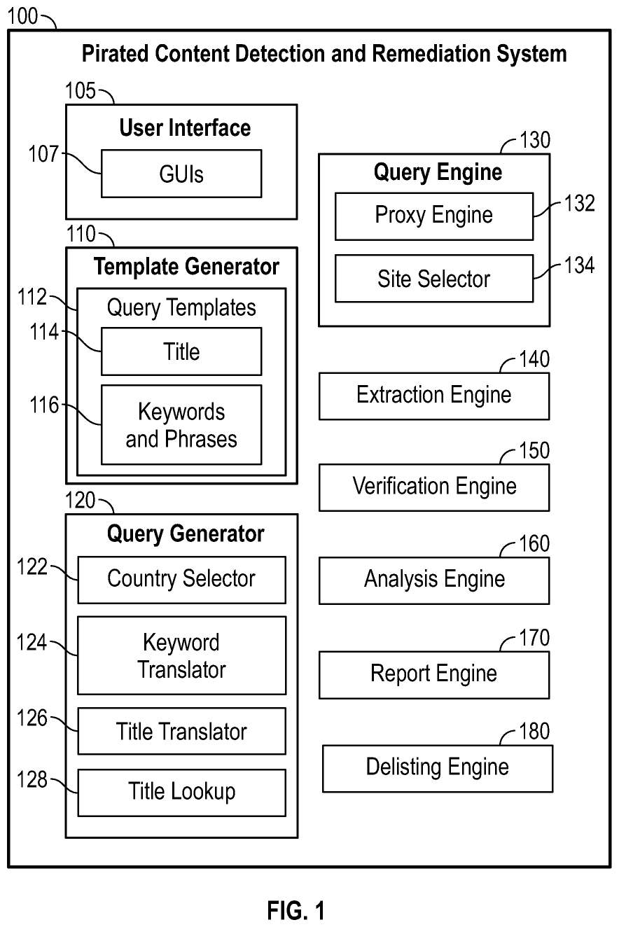

FIG. 1 is a block diagram of an exemplary pirated content detection, analysis, and remediation system 100 for detecting, analyzing, and/or facilitating the delisting of pirated content indexed by Internet search engines in accordance with embodiments of the present disclosure. Content can include, for example, copyrighted materials or media, such as visual, audio, and/or visual-audio recordings and/or streams (e.g., movies, music, concerts, sporting events, including prerecorded and live streams), software, video games, e-books, documents, etc. that have been made available/accessible over a network, such as the Internet. The system 100 can simulate local user traffic behavior for the Internet in various countries to provide a global search scope with customized queries for localized searching in the countries. The system 100 can use a local version of the search engine, where available (e.g., a search engine mirror). For example, rather than using the main website, “google.com”, to conduct a search in Germany, the system 100 can use the mirror site, “google.de”, which is the corresponding German website. When there is no available local mirror in a country, the system 100 can use the main website for that country. In addition, the system 100 can use local HTTP proxies to run the searches. Still using Germany as example, this means the system 100 can run German search queries through a German proxy IP address on the mirror site “google.de”. The system 100 can include a user interface 105, a template generator 110, a query generator 120, a query engine 130, an extraction engine 140, a verification engine 150, analysis engine 160, a report engine 170, and a delisting engine 180.

The user interface 105 can be programmed and/or configured to provide one or more graphical user interfaces (GUIs) 107 through which users of the system 100 can interact with the system 100. The user interface 105 may be generated by embodiments of system 100 being executed by one or more servers and/or one or more user/client computing devices. In exemplary embodiments, the user interface 105 can provide an interface between the users and the other components. The GUIs 107 can be rendered on display devices and can include data output areas to display information to the users as well as data entry areas to receive information from the users. For example, data output areas of the GUIs 107 can output information associated with search results; URLs; domains; content piracy activities and accessibility; visualizations including graphs, maps, images, tables, and charts; predictive/probabilistic estimates and/or scores, e.g., associated with the likelihood that pirated content will be accessed instead of the authorized content; analysis of the associated content piracy; and any other suitable information to the users via the data outputs. The data entry areas of the GUIs 107 can receive, for example, information associated with user information, content titles, keywords, country selections, domain selections, menu options, and any other suitable information from users. Some examples of data output areas can include, but are not limited to text, visualizations (e.g., graphs, maps (geographic or otherwise), images, tables, charts and the like), and/or any other suitable data output areas. Some examples of data entry fields can include, but are not limited to text boxes, check boxes, buttons, dropdown menus, and/or any other suitable data entry fields.

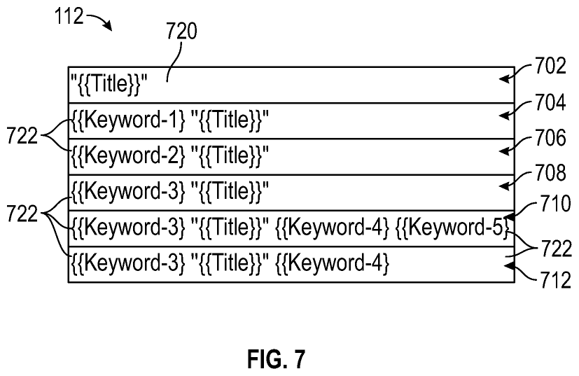

The template generator 110 can generate query templates 112. The query templates 112 can provide an input seed for the query generator. The query templates 112 can be a data structure that includes content titles 114 and keywords 116 that can be combined according to the structure of the query template 112 to form one or more parameters of the input seed. As a non-limiting example, a query template 112 can include parameters, such as “title”; “download ‘{{Title}}’”, where “download” can represent a keyword and “{{Title}}” can represent a placeholder for the content title. The template generator 110 can select keywords for a query template based on statistics and historic data associated with keywords and the effectiveness of the keywords in returning relevant results. An example query template 112 that can be generated by the template generator 110 is illustrated with reference to FIG. 7. To define actual keywords to be replaced in the query template, data from SimilarWeb, Google Trends, and/or proprietary processes can be used to facilitate identification of most effective queries and/or actual keywords that have historically resulted in search results including pirated content for the specified content types. The actual keywords to be replaced in the query template can also include system defined keywords that provide additional specificity associated with the content beyond the title of the content, for example to disambiguate the specific content that will be the subject of the queries. As an example, if the content is a television series, the title may be the name of the television series, but does not provide any details about which season and which episode of the television series will be the subject of the search. In this example, additional keywords for the season, episode, and/or the name of the episode may be specified when creating queries using the query templates. As another example, for software content, the title may provide the name of the software product/service, but does not provide any details about which version, subscription level, or grade of the software product/service will be the subject of the search. In this example, additional keywords for the version (e.g., version 12, subscription level (e.g., basic, premium), and/or grade (e.g., pro) of the software product/service may be specified when creating queries using the query templates. As yet another example, for literature, such as an e-book, the title can represent the name of the e-book and it may be possible the name of the book is not unique, which may result in irrelevant results. In this example, additional keywords for the author(s), edition, and/or publisher of the e-book may be specified when creating queries using the query templates.

The query generator 120 can process each parameter in the query template 112 to generate localized search queries. Each country within which searches for pirated content will be executed can be represented in a country selector 122. For each of those countries, the query generator can use the keyword translator 124, the title translator 126, and title lookup 128 in order to create sets of localized search queries by replacing the placeholders in each query template 112 with the translated/local version of the keywords and title in the languages associated with each country. In some embodiments, the system 100 can default to select all available countries. A country can be determined to be relevant for content piracy by different criteria, e.g., if the country has at least 50% of their population as internet users. The countries to be considered can be divided into two groups: a Core Coverage group to be covered by the system 100 and a Regional Coverage group which includes more specific countries that users may want to cover.

During the query generation process, the sets of localized search queries for the selected countries can be created using the primary, secondary, tertiary, official, and/or unofficial languages of relevance for each of the countries. The translation of a query template 112 into sets of localized search queries entails two parts: a translation of keywords via a keyword translator 124 (e.g. “watch” in English becomes “assistir” in Portuguese) and a translation of content titles via a title translator 126. The sets of localized search queries can be created by translating the keyword parameters into the most commonly spoken languages in each country of interest to ensure a realistic simulation of local user behavior. That is, rather than simply using a country's official language(s), the system 100 uses secondary languages or unofficial languages which are also spoken in that country in addition to the official language(s). The title lookup module 128 can generate a table of the countries within which the content was officially released and the corresponding official launch name/title of the content in those countries in the language(s) spoken in those countries. In an example embodiment, the title translator 126 can interface with the title lookup module 128 to retrieve the official launch name/title of the content in each country in the language(s) spoken in each country from the table. The table of the official titles for content in different countries can be created by querying third party data sources that include the official launch name/titles and adding the official launch names/titles to the table. Thus, in example embodiments, rather than performing a literal translation of the title information or keep using the original title name, the system 100 can be executed to replace the title information with a specified country-specific title by which the content is known or marketed in the selected country.

The query engine 130 can receive the sets of country-specific localized search queries generated by the query generator 120 and can execute the sets of country-specific localized queries in their corresponding countries. To achieve this, the query engine 130 can include a proxy engine 132 that can generate and/or specify proxy servers in the countries corresponding to the sets of country-specific queries. As an example, if searches for pirated content are identified for execution in France, Germany, and Italy, the proxy engine 132 can identify proxy servers in France, Germany, and Italy, and can transmit the sets of country-specific localized search queries to the proxy server in each respective country with instructions to execute the sets of country-specific localized search queries using the IP address of the proxy servers, by incorporating the queries in local HTTP requests that are submitted by each respective proxy server to each search engine to be used. In some embodiments, a default search engine can be specified by the system 100, or the query engine 130 can include a site selector 134 that can allow a user to select search engines to be searched within the countries. As an example, the site selector 134 can be programmed to select one or more search engine websites, mirror sites for one or more search engines, and/or one or more application programming interfaces (APIs) associated with the search engine or the mirror site for the search engine. As an example, the site selector 134 can receive the selected countries within which searches for pirated content are conducted and can receive the set of localized search queries in different languages associated with each of the selected countries. Based on this input information, the site selector can submit the sets of country-specific localized queries to search engines or mirror sites for the search engines in the selected countries via the proxy server using the proxy IP address.

In the exemplary embodiment, the results returned by the search engines are stored by the system with information about the query that caused the results to be returned and the country from which the results are returned. As an example, each result (e.g., each hyperlink, URL, and/or domain for a webpage) can be stored as a file or other data structure. In some instances, one or more of the results can be stored in the same format as it is on the data source from which it is retrieved. In some instances, one or more of the results can be stored in a different format than the format in which it is stored on the data source from which it is retrieved.

The extraction engine 140 extracts content and information (including metadata) from each result (e.g., each hyperlink, metadata, and/or the actual webpage referenced by the hyperlink). In an exemplary embodiment, the content and information extracted from the results can include domain names, Uniform Resource Locators (URLs), Uniform Resource Identifiers (URIs), website information (e.g., information, such as images and/or text included in the body of the webpage and/or information or text included in the source code for the webpage including the link text, href, HTML page title, etc.), hyperlinks to the pirated content, samples of the pirated content in media types such as images, audio, and/or audiovisual content including video streams, a PDF file of an e-book or document, all of which with the purpose of verifying them against reference digital fingerprints or digital signatures of the content), and the like.

As the extraction engine 140 extracts the content and information from each result, the extraction engine 140 can build and/or update a database with the content and information from the results. The extraction engine 140 can create records in the database for each result and can store the content and information extracted from each result as data in data fields in their respective records. In addition to the data fields for storing data extracted from the results, the records in the database can include additional data fields based on a determination of whether the results corresponding to the records provide access to pirated content. For example, each record can include a data field that includes a label of infringing/pirated or non-infringing/authorized.

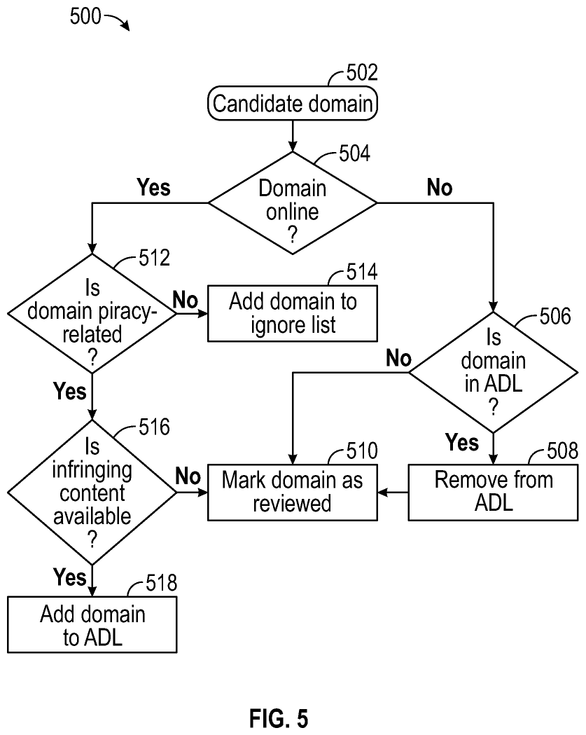

The verification engine 150 can be programmed to assess whether the search results are infringing, i.e., whether the search results lead to pirated content or not. The verification of the search results can include two processes that can be performed in parallel. In one of the processes performed via the verification engine 150, all unique domains that appear in search results are reviewed to identify a purpose of each website listed in the search results, e.g., to understand if any of the websites have digital piracy as their main activity. If so, these websites are added to an Approved Domain List (ADL), where “Approved” means these websites can be targeted for delisting from search engines when it is determined that a search engine index contain hyperlinks for the domains included in the ADL (i.e., the websites are approved for delisting. This can ensure accuracy in delisting only pirate domains. An example of a process for assigning the results to Approved Domain List is described herein with reference to FIG. 5.

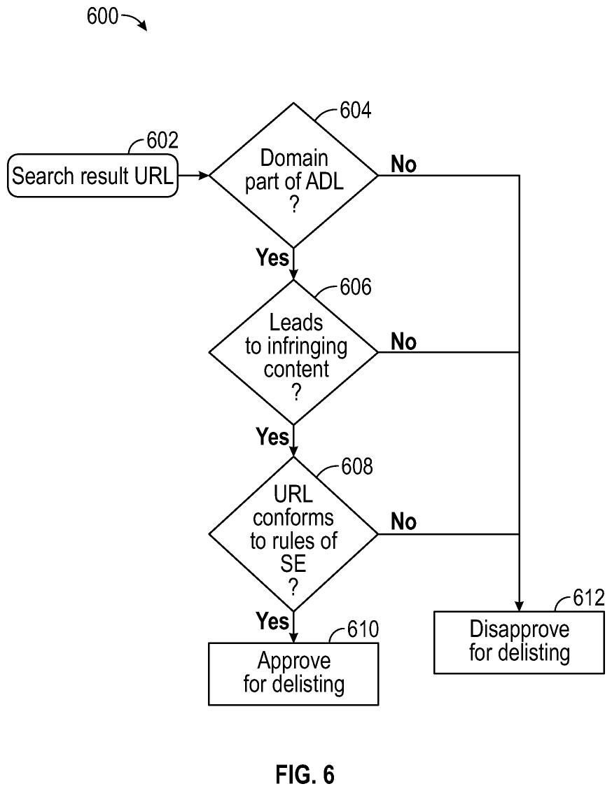

In another process performed via the verification engine 150, each search result is assessed to determine whether the search result leads to pirated content or not. Using this verification process, it can be determined whether a given search result should be delisted because it infringes a copyright of an owner of the content. As part of this process, it can be determined whether websites returned in the search results include pirated content that is accessible by users. As an example, the verification engine 150 can inspect the search results to determine whether the hyperlinks and associated domains are operational and/or have a correct structure, determine whether the metadata associated with the result includes or omits certain keywords or includes other information. As another example, the verification engine 150 can inspect the actual website in response to activating the hyperlink in a result, to determine the information included in the website and/or can determine whether the content is actually accessible via the website associated with the hyperlink in the result. The verification engine 150 can associate labels with each of the search results (e.g., infringing/pirated or non-infringing/authorized) based on this process. An example of a process for verifying whether results provide access to pirated content is described herein with reference to FIG. 6.

As part of the extraction and/or verification processes, in some embodiments, the extraction engine 140 can extract information from the search results and/or the verification engine 150 can verify whether the results are infringing or not using, for example, natural language processing, machine learning, similarity measures, digital signatures of the content compared to digital signatures of the content accessible via the results, image matching techniques including pixel matching, and/or pattern matching techniques to identify item identifiers in the results. Various algorithms and/or techniques can be utilized by extraction engine 140 and/or the verification engine 150. For example, algorithms for fuzzy text pattern matching, such as Bacza-Yates-Gonnet can be used for single strings and fuzzy Aho-Corasick can be used for multiple string matching; algorithms for supervised or unsupervised document classification techniques can be employed after transforming the text into numeric vectors: using multiple string fuzzy text pattern matching algorithms such as fuzzy Aho-Corasick; using topic models such as Latent Dirichlet Allocation (LDA) and Hierarchical Dirichlet Processes (HDP); and/or using decision tree algorithms, such as Random Forest and/or Boosted Tree algorithms to verify whether search results are infringing.

The analysis engine 160 can use the search results (including the information and metadata extracted from the search results) and/or the outcome of the verification processes to generate metrics and/or analytics for the results that can provide insight regarding trends and risks associated with the distribution of pirated content over the networking in countries as well as metrics and/or analytics regarding how authorized distribution sources compare to the alternative pirated content distribution sources. The analysis performed by the analysis engine 160 can be specific to the title of content that was used for a search and/or can be performed more generally based on searches conducted from multiple titles of content that are unrelated and independent from each other. As an example, the analysis engine 160 can determine within which countries a specific title of content is being pirated the most and/or the least, and/or can determine within which countries the content in general is being pirated the most and/or the least. The analysis engine can provide a total number of websites providing access to pirated content and/or to content that is provided with authorization.

The analysis engine 160 can use the results to generate a piracy exposure score that can provide insight into the likelihood that the pirated content in the results will be accessed. That is, the piracy exposure score is a probability that a pirate search result (i.e. one that leads to pirate content) will be visited by a consumer from any possible search results lists. The piracy exposure score can be based on the analysis of click-through rate research, which can closely reflect consumer behavior online by assigning higher probability of clicking on search results that appear higher on a search results page, as well as lower probability of clicking on search results that appear lower on a search results page. When multiple queries are executed, a particular pirate search result can appear in position A in one set of search results, can appear in position B in another set of search results, and can appear in position C in yet another set of search results. These events (the position of the pirate search result) can be considered to be mutually exclusive, i.e., a pirate search result cannot appear twice as a result of one search. Therefore, the piracy exposure score can be represented as the probability that the hyperlink will appear at either of possible positions.

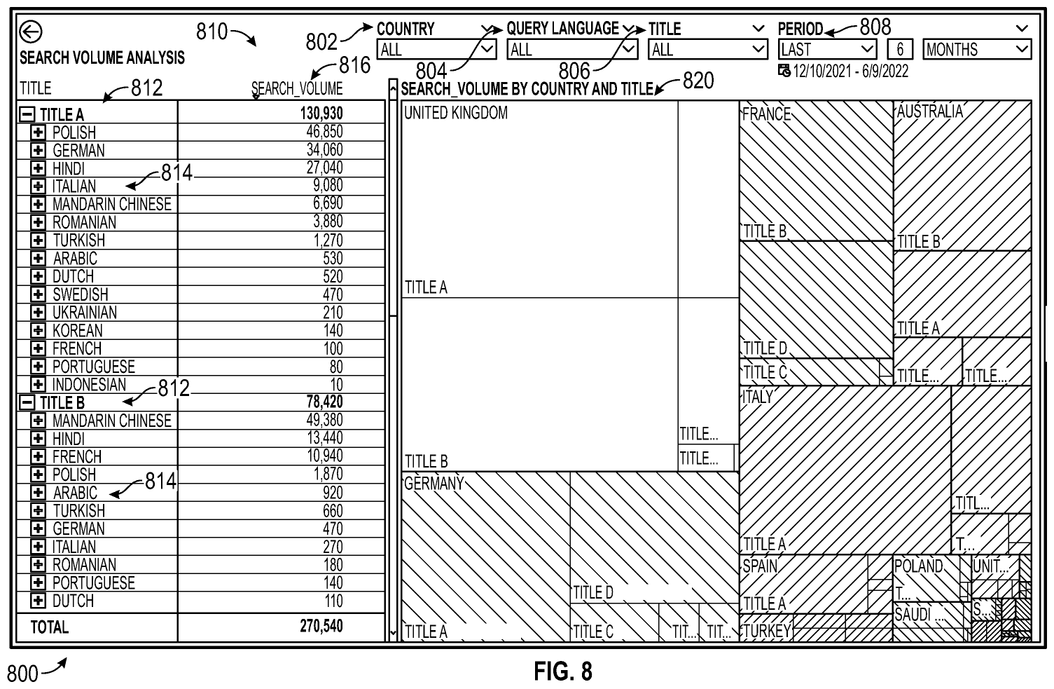

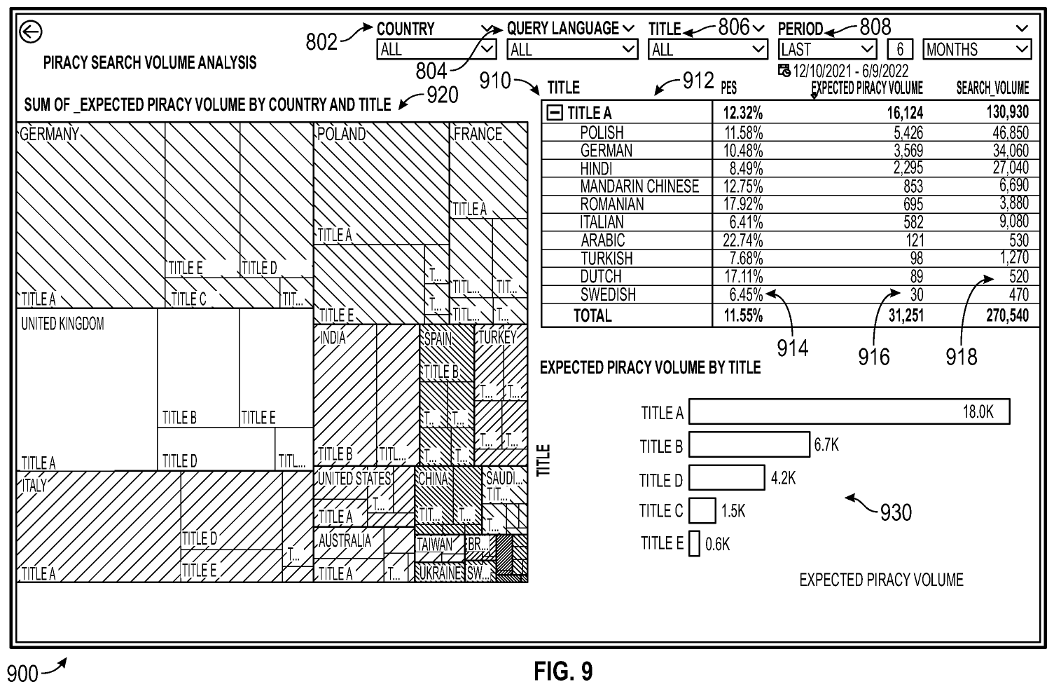

The analysis engine 160 can estimate demand for a certain title within a local consumer population as well as estimate how many consumers of that population are likely to engage with a pirate alternative from search results that they observe when searching in their local languages. The demand can be estimated by taking each query generated by the query generator 120 for each country and language combination and sourcing search volume data from a third party like Google Ads for each of those queries. The estimation of how many consumers are likely to engage with a pirate alternative can be done by multiplying the piracy exposure score of a specific query by the search volume for the same specific query, considering the same time period for both values, as well as same country and language. As one example, the analysis engine 160 can calculate the demand for a specific title in a specific country by summing the search volume for all country-specific queries in a specified time period. As an additional example, if the piracy exposure score for the past 30 days was 8% for a specific query X, and the total search volume was 50,000, the number of consumers likely to engage with pirate alternatives can be estimated by multiplying the two values, reaching 4,000. Reports can be generated by the report engine 170 to help in understanding demand for content as well as for estimating the number of consumers that would engage with pirate alternatives to consume that content in specific countries and languages. The reports can be interactive allowing users of the system 100 to select a country, language, or title in the report to filter other reports by the selected values. Example graphical user interfaces for illustrating the reports for analyzing search demand are shown in in FIGS. 8 and 9.

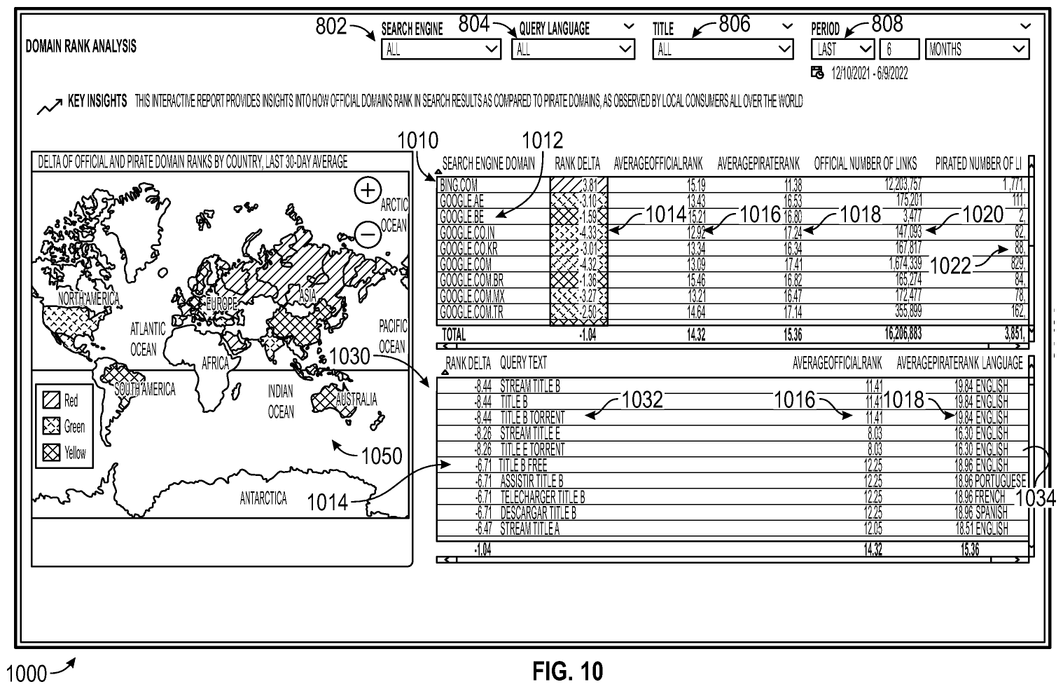

The analysis engine 160 can also determine how domains or sites providing access to piracy rank in search results relative to official domains representing authorized distribution channels. The comparison between the two can be calculated by a rank delta, subtracting the average rank of pirate domains from the average rank of official domains as observed for each search query. A negative delta means that official domains are appearing higher in search result pages, i.e. above pirate domains, and vice-versa. Reports can be generated by the report engine 170 using the rank delta to show where official domains rank higher than pirate domains, and vice-versa. Example graphical user interfaces for illustrating the reports for analyzing official versus pirate domains are shown in FIGS. 10, 11 and 12.

The report engine 170 can generate one or more reports or presentations based on parameters, metrics, and/or statistical information associated with the search results. For example, the report engine can use the information and data generated by the analysis engine 160 and the verification engine 150 to generate tables, graphs, charts, images, maps, and the like corresponding the parameters, metrics, and/or statistical information associated with the search results, such as the examples illustrated in FIGS. 10-13.

The delisting engine 180 can automatically generate one or more delisting requests and can transmit the delisting requests to the one or more search engines to have websites that include pirated content removed from the index of the search engines, such that the websites will no longer be returned by the search engine in response queries. As a non-limiting example, the delisting engine 180 can initiate an automated delisting of detected pirated content. Once a search result has been labelled as providing access to pirated content, the delisting engine 180 can initiate a request to delist the search result from the index of the search engine by generating e.g., a structured file, e-mail, submitting a web form, and/or interfacing with an API of the search engine.

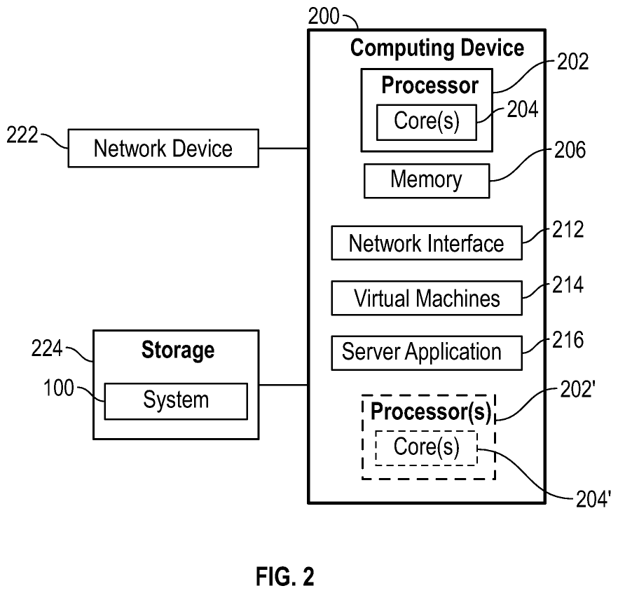

FIG. 2 is a block diagram of an exemplary computing device in accordance with embodiments of the present disclosure. In the present embodiment, computing device 200 can be configured as a server that is programmed and/or configured to execute one or more of the operations and/or functions of system 100 and to facilitate detection and delisting of pirated content indexed by Internet search engines. Computing device 200 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 206 included in computing device 200 may store computer-readable and computer-executable instructions or software for implementing exemplary embodiments of system 100 or portions thereof.

Computing device 200 also includes configurable and/or programmable processor 202 and associated core 204, and optionally, one or more additional configurable and/or programmable processor(s) 202′ and associated core(s) 204′ (for example, in the case of computer systems having multiple processors/cores), for executing computer-readable and computer-executable instructions or software stored in the memory 206 and other programs for controlling system hardware. Processor 202 and processor(s) 202′ may each be a single core processor or multiple core (204 and 204′) processor.

Virtualization may be employed in computing device 200 so that infrastructure and resources in the computing device may be shared dynamically. One or more virtual machines 214 may be provided to handle a process running on multiple processors so that the process appears to be using only one computing resource rather than multiple computing resources, and/or to allocate computing resources to perform functions and operations associated with system 100. Multiple virtual machines may also be used with one processor or can be distributed across several processors.

Memory 206 may include a computer system memory or random-access memory, such as DRAM, SRAM, EDO RAM, and the like. Memory 206 may include other types of memory as well, or combinations thereof.

Computing device 200 may also include one or more storage devices 224, such as a hard-drive, CD-ROM, mass storage flash drive, or other computer readable media, for storing data and computer-readable instructions and/or software that can be executed by the processor 202 to implement exemplary embodiments of system 100 described herein.

Computing device 200 can include a network interface 212 configured to interface via one or more network devices 222 with one or more networks, for example, Local Area Network (LAN), Wide Area Network (WAN) or the Internet through a variety of connections including, but not limited to, standard telephone lines, LAN or WAN links (for example, 802.11. T1, T3, 56 kb, X.25), broadband connections (for example, ISDN, Frame Relay, ATM), wireless connections (including via cellular base stations), controller area network (CAN), or some combination of any or all of the above. The network interface 212 may include a built-in network adapter, network interface card, PCMCIA network card, card bus network adapter, wireless network adapter, USB network adapter, modem or any other device suitable for interfacing computing device 200 to any type of network capable of communication and performing the operations described herein. While computing device 200 depicted in FIG. 2 is implemented as a server, exemplary embodiments of computing device 200 can be any computer system, such as a workstation, desktop computer or other form of computing or telecommunications device that is capable of communication with other devices either by wireless communication or wired communication and that has sufficient processor power and memory capacity to perform the operations described herein.

Computing device 200 may run any server application 216, such as any of the versions of server applications including any Unix-based server applications, Linux-based server application, any proprietary server applications, or any other server applications capable of running on computing device 200 and performing the operations described herein. An example of a server application that can run on the computing device includes the Apache server application.

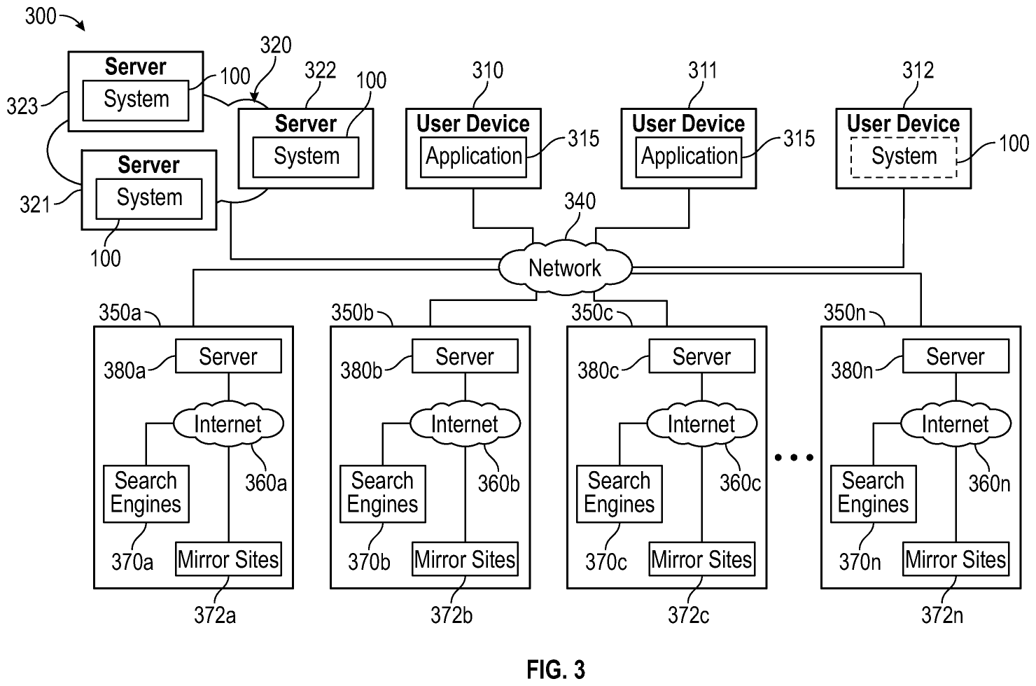

FIG. 3 is an exemplary networked environment 300 for facilitating detection, analysis, and remediation of pirated content indexed by Internet search engines in accordance with embodiments of the present disclosure. Environment 300 includes user computing devices 310-312 operatively coupled to a computing system 320 that includes one or more server computing devices (servers) 321-323, via a network 340, which can be any network or combination of networks over which information can be transmitted between devices communicatively coupled to the network. The user computer devices 310-312 and servers 321-323 can each be embodied as an embodiment of the computing device 200. The network 340 can be the Internet, an Intranet, virtual private network (VPN), wide area network (WAN), local area network (LAN), and the like. Environment 300 can include repositories or databases 330, which can be operatively coupled to servers 321-323, as well as to user computing devices 310-312, via the network 340. Those skilled in the art will recognize that the database 330 can be incorporated into one or more of servers 321-323 such that one or more of the servers can include databases. In an exemplary embodiment, embodiments of system 100 can be implemented, independently or collectively, by one or more of servers 321-323, can be implemented one or more of the user computing devices (e.g., the user computing device 312), and/or can be distributed between servers 321-323 and the user computing devices 310-312.

User computing devices 310-312 can be operated by users to facilitate interaction with system 100 implemented by one or more of servers 321-323. In exemplary embodiments, the user computing devices (e.g., user computing device 310-311) can include a client-side application 315 programmed and/or configured to interact with one or more of servers 321-323. In one embodiment, the client-side application 315 implemented by the user computing devices 310-311 can be a web-browser capable of navigating to one or more web pages hosting GUIs of system 100. In some embodiments, the client-side application 315 implemented by one or more of user computing devices 310-311 can be an application specific to system 100 to permit interaction with system 100 implemented by the one or more servers (e.g., an application that provides user interfaces for interacting with servers 321, 322, and/or 323).

The one or more servers 321-323 (and/or the user computing device 312) can be in communication with one or more proxy servers computer devices (proxy servers) 380a-n each being located in a different country 350a-n. As an example, the proxy server 380a can be located in Country A 350a, the proxy server 380b can be located in Country B 350b, and the proxy server 380c can be located in Country C 350c, and so on. The one or more servers 321-323 (and/or the user computing device 312) can execute system 100 to search for content in the countries 350a-n that is available over the Internet 360a-360n in the countries 350a-n via search engines 370a-n and/or mirror sites 372a-n for the search engines using the proxy servers 38a-n. As an example, the system 100 can be programmed to generate a set of queries based on a query template for specified content, which can be translated and optimized for each of the countries 350a-n such that a set of country-specific queries are generated for country 350a-350n. The system 100 can transmit each set of country-specific queries to one of the proxy servers 380a-n corresponding to the country associated with the country-specific set of queries. As an example, a set of country-specific queries for the Country A 350a can be transmitted to the proxy server 380a, a set of country-specific queries for the Country B 350b can be transmitted to the proxy server 380b, and a set of country-specific queries for the Country C 350c can be transmitted to the proxy server 380c. Upon receiving a set of the country-specific queries, the proxy servers 380a-n can transmit the country-specific sets of queries to the corresponding search engines 370a-n and/or mirror sites 372a-n in their respective countries such that proxy IP addresses corresponding to the proxy servers are associated with the sets of country-specific queries. The search results from the sets of country-specific queries can be transmitted back to the proxy server 380a-n by the search engines 370a-n and/or 372a-n in the respective countries 350a-n and the proxy server 380a-n can transmit the search result back to the one or more servers 321-323 (and/or the user computing device 312). As an example, the search results returned by the search engines 370a-n or mirror sites 372a-n can include a ranked list (e.g., by relevancy) of URLs including content that may be relevant to the search terms of the sets of country-specific queries. The system 100 can be programmed to process the search results as described herein.

Databases 330 can store information for use by system 100. For example, databases 330 can store query templates, sets of queries generated based on the query templates, search results corresponding to the sets of queries, data and/or information generated by the system based on the search results, and/or any other suitable information/data that can be used by embodiments of system 100, as described herein.

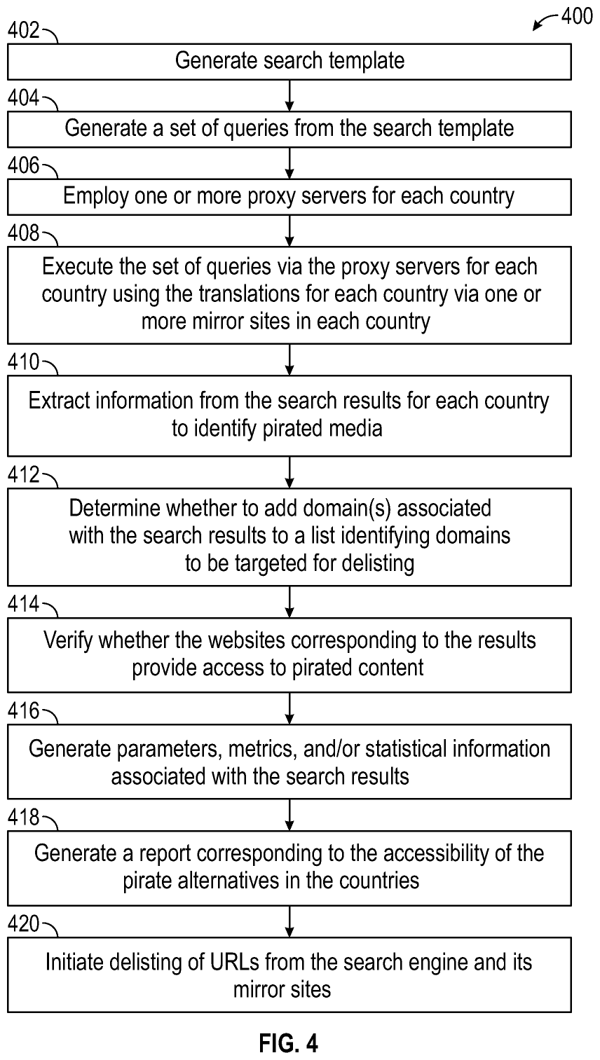

FIG. 4 is a flowchart illustrating an example process 400 for detecting, analyzing, and facilitating the delisting of pirated content indexed by Internet search engines in accordance with embodiments of the present disclosure. The process can be implemented by an embodiment of the system 100 executed by one or more processors associated with one or more computing devices (e.g., described with reference to FIGS. 2 and 3). At operation 402, a search template is generated via execution of the system 100 by the one or more processors. At step 404, the system can be executed to generate a set of country-specific localized search queries from the search template. For example, the system 100 can be executed by the one or more processors to create combinations and permutations of possible queries based on the title and keywords and phrases in the search template in one or more languages associated with one or more countries within which the searches will be executed as described herein.

At step 406, the system 100 can be executed by one or more processors to employ one or more proxy IP addresses using one or more proxy servers geographically located in each of the selected countries. At step 408, the set of country-specific localized queries can be executed via respective ones of the proxy servers in the selected countries via one or more search engine websites or APIs and/or one or more mirror sites or APIs for the one or more search engines in the selected countries. As an example, the system 100 is executed to transmit http requests including a set of country-specific queries from an originating server in a first country to a proxy server in the second country and the proxy server can submit the http requests to the country-specific search engine website or API, which can be a mirror site for the search engine that operates within the selected country which provides search results that are specific to or biased towards the selected country. The proxy server submits the http request to the search engine and/or the mirror site or API for the search engine using an IP address that is different from the IP address of the originating server. For example, the proxy server replaces the IP address in the original http request with a new (proxy) IP address that is specific the selected country so that the search engine or mirror site for the search engine identifies the http requests as originating within the selected country.

At step 410, information from the search results returned by the search engine website and/or mirror site or API for the search engine are extracted by the system 100 being executed by the one or more processors. As a non-limiting example, the system 100 can parse and extract the information (including metadata) from the websites in the search results using machine learning, natural language processing, text matching, similarity measures, digital signatures and/or fingerprints for the content. At step 412, the system 100 is executed to verify whether the domains associated with the search results are associated with the distribution of pirated content, and if so, the system 100 adds the domains to a list identifying domains to be targeted for delisting from the search engine(s) (e.g., as described with reference to FIG. 5). At step 414, the system can be executed to determine which of the websites in the search results that have been identified as including or facilitating access to pirated content associated with the set of localized queries (e.g., as described with reference to FIG. 6. In example embodiments, steps 412 and 414 can be executed in parallel or in any order.

At step 416, the system 100 is executed by the one or more processors to analyze the search results and the outcomes of the verification processes to generate parameters, metrics, and/or statistical information associated with the search results, and at step 418, the system 100 is executed by the one or more processors to generate a report corresponding to the accessibility of the pirated content in the one or more selected countries. At step 420, the system 100 is executed by the one or more processors to initiate delisting of the websites from the search engine index and/or from index associated with one or more of the mirror sites for the search engine.

FIG. 5 is a flowchart to illustrate a process 500 for identifying Internet domains that provide access to unauthorized content and which therefore can be approved for delisting from search engine indexes in accordance with embodiments of the system 100. In an example embodiment, the process 500 can be executed at a specified frequency, e.g., hourly, daily, weekly, monthly, quarterly, yearly, and the like. At step 502, a candidate domain which has previously figured in search results is checked to see if it should be approved or disapproved for delisting purposes. At step 504, the domain is checked to see if it is currently online. If it is not online, it is checked for presence in the approved domain list (ADL) at step 506. If it is present in the ADL, then it is removed from the ADL at step 508. After that or if the candidate domain was not in the ADL, the candidate domain is marked as reviewed at step 510. If the domain is online, it is tested to see if it is piracy-related in step 512. As a non-limiting example, a domain can be considered piracy-related if its main focus is to aggregate links to unauthorized copies of copyrighted content. If the domain is not piracy-related, it is then added to an ignore list at step 514, which signifies that search results from the domain will not be considered for delisting. An example of such domain can be an official web site distributing the content legitimately. If the domain is piracy-related an additional check is made at step 516 to see if pirate content of interest is available via the domain. If infringing content is available, then the domain is added to the approved domain list in step 518, which means that the domain can become target of delisting notices. If no infringing content is available, then the domain is marked as reviewed at step 510.

FIG. 6 illustrates a delisting verification process 600 in accordance with embodiments of the system 100. The process 600 can be performed to evaluate search results to decide whether they should be delisted due to copyright infringement. At step 602 a candidate search result URL is taken up for evaluation. At step 604 the domain of the URL is checked against the approved domain list (ADL) constructed as per the process described in FIG. 5. If the domain is not part of the ADL then the search result is disapproved for delisting at step 612. If the domain is part of the ADL a verification is done at step 606 to see if the search result leads to infringing content. As a non-limiting example, a search result can be deemed to lead to infringing content if the landing page that is rendered when clicking the search result allows for playing or downloading unauthorized copies of content. If the search result does not lead to infringing content, the search result is disapproved for delisting at step 612. If the search result leads to infringing content a check is performed at step 608 to see if the URL is in conformity to the rules stipulated by search engines for delisting purposes. If the URL does not conform to the rules it is then disapproved for delisting at step 612. If the URL conforms to the rules, the URL is approved for delisting at step 610.

FIG. 7 depicts an example query template 112 that can be generated by an embodiment of the system 100. The query template can include query parameters 702-712 that can be used by the system 100 to generate sets of queries as described herein. The parameters can include a title 720 of content that is the subject of the search. The parameters can also include keywords 722 that can be used in combination with the title 720 by the system 100 to generate the set of searches. The query template 112 can give rise to actual search queries after a series of combination and/or permutations employed and after localizing of the search queries for specific countries is complete. As a non-limiting example, the query template can include the most used basic search terms that consumers use while searching for a way to access pirated content. This methodology can target audiovisual content (e.g. movies, TV series, live sports) and/or can be used to target other types of content such as software, video games, e-books, etc.

FIG. 8 is a graphical user interface 800 that illustrates a search volume analysis report (e.g., overall search volume for results including authorized and pirated content) that can be performed in accordance with embodiments of the present disclosure. For example, queries generated by the system for one or more titles of content that have been executed in different countries (e.g., via proxy servers and search engine mirror sites) and different languages can be tracked over time and stored by the system 100. The graphical user interface 800 allows a user to filter the queries to provide an interactive presentation of various parameters associated with the search queries. As an example, the graphical user interface 800 includes a country filter 802, a language filter 804, a title filter 806, and a time period filter 808. The country filter 802 allows the user to limit the results displayed by the graphical user interface 800 to one or more specified countries. The language filter 804 allows the user to limit the results displayed by the graphical user interface 800 to one or more specified languages. The title filter 806 allows the user to limit the results displayed by the graphical user interface 800 to one or more specified titles for searched content. The time period filter 808 allows the user to limit the results displayed by the graphical user interface 800 to a specified time period.

As shown in FIG. 8, and as a non-limiting example, the graphical user interface 800 can include one or more visualizations of search volumes. As one example, the graphical user interface 800 can include a list 810 by title 812 and the language 814 in which the search queries were generated. The list 810 can provide parameters associated with the searches for the titles and languages in which the queries were generated. As an example, the list 810 can include an overall search volume 816 (a quantity of searches executed) for a title and a breakdown of the search volume by the language in which the search queries were generated and a breakdown of the search volume by the language in which the search queries were generated. As another example, the graphical user interface can include a tree map 820 that illustrates the data in the list in a graphical form which allows the user to quickly determine which countries contributed most to the search volume for the specified or more titles.

FIG. 9 is a graphical user interface 900 that illustrates a piracy search volume analysis (e.g., a subset of search volume for results including pirated content) that can be performed in accordance with embodiments of the present disclosure. The graphical user interface 900 allows a user to filter the queries to provide an interactive presentation of various parameters associated with the search queries. As an example, the graphical user interface 900 includes the country filter 802, the language filter 804, the title filter 806, and the time period filter 808.

As shown in FIG. 9, and as a non-limiting example, the graphical user interface 900 can include one or more visualizations of the piracy search volumes. As one example, the graphical user interface 900 can include a list 910 by title and language in which the search queries were generated 912. The list 810 can provide parameters associated with the searches for the titles and languages in which the queries were generated. As an example, the list 810 can include the calculated piracy exposure score (PES) 914 for each title and/or language in which the queries were generated, an expected piracy volume 916 for each title and/or language in which the queries were generated, and the overall search volume 816 for a title and a breakdown of the search volume by the language in which the search queries were generated. As another example, the graphical user interface 900 can include a tree map 920 that illustrates the cumulative expected piracy volume by country and title in the list in a graphical form which allows the user to quickly determine which countries contributed most to the piracy search volume for the specified or more titles. As another example, the graphical user interface can include a bar graph 930 that illustrates the expected piracy volume by title.

FIG. 10 is a graphical user interface 1000 that illustrates a domain rank analysis that can be performed in accordance with embodiments of the present disclosure. The graphical user interface 1000 allows a user to filter the queries to provide an interactive presentation of various parameters associated with the search queries. As an example, the graphical user interface 1000 includes the country filter 802, the language filter 804, the title filter 806, and the time period filter 808.

As shown in FIG. 10, and as a non-limiting example, the graphical user interface 1000 can include one or more visualizations of the domain rank analysis. As one example, the graphical user interface 1000 can include a list 1010 by search engine/domains 1012 by which the search queries were executed. The list 1010 can provide parameters associated with the search engines/domain. As an example, the list 1010 can include the rank delta parameter 1014 for each search engine/domain, an average official rank 1016 for each search engine/domain, an average rank of pirate domains 1018 for search engine/domain, an official number of links 1020 for each search engine/domain, and a pirated number of links 1020 for each search engine/domain. As another example, the graphical user interface 1000 can include a list 1030 by the rank delta parameter 1014 and query text 1032. The list 1030 can include the average official rank 1016, the average rank of pirate domains 1018 for search engine/domain, a language 1034 of the query text. As another example, the graphical user interface 1000 can include an interactive geographic map 1050 including countries and/or regions of the world that enables users to quickly identify countries or regions where content piracy is occurring more frequently. For example, the interactive geographic map 1050 can be color coded the indicate the occurrence of piracy for specific content and titles, where the color “red” can identify countries where users are most likely to lose customers to illegal content providers (pirates), green identifies countries where the risk of losing customers to piracy is low, and yellow identifies countries that are relatively in between countries with a high likelihood and a low likelihood of losing customers to piracy.

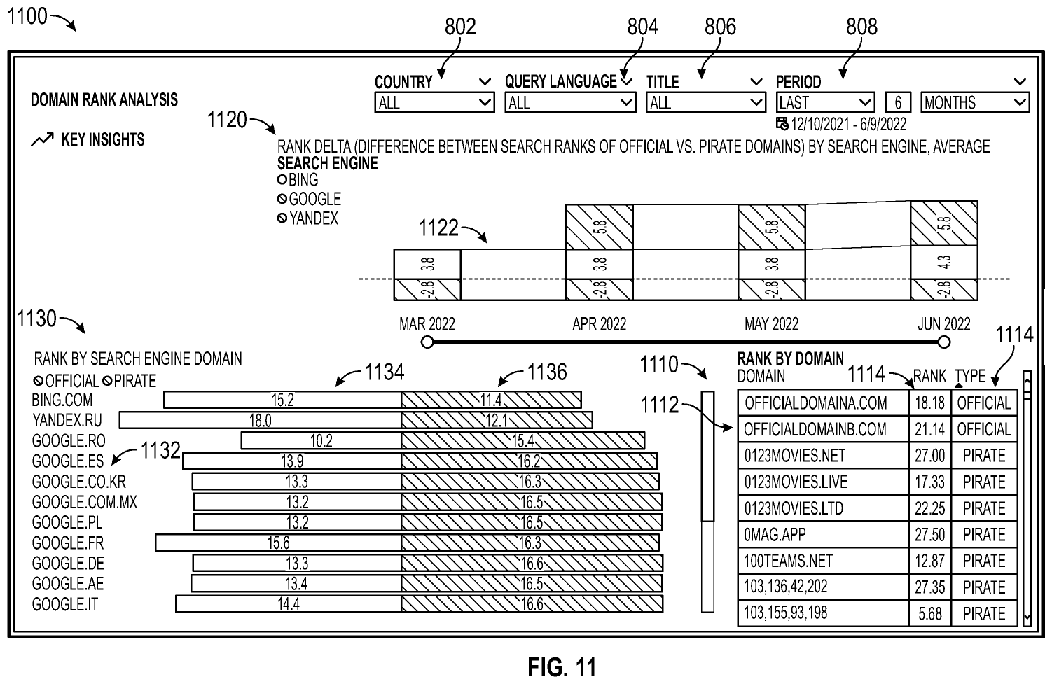

FIG. 11 is another graphical user interface 1100 that illustrates a domain rank analysis between domains providing authorized access to content and domains providing pirated content in accordance with embodiments of the present disclosure. The graphical user interface 1100 can provide an analysis of link ranks, where ranks of links to official/authorized domains on the search engines can be compared with links to unofficial/pirate domains. Rank delta scores can be calculated to indicate how official domains are ranking against pirate domains. A negative delta indicates that the official/authorized domains are out ranking the unofficial/pirate domains in the search engine results. The graphical user interface 1100 allows a user to filter the queries to provide an interactive presentation of various parameters associated with the search queries. As an example, the graphical user interface 1100 includes the country filter 802, the language filter 804, the title filter 806, and the time period filter 808.

As one example, and as a non-limiting example, the graphical user interface 1100 can include a list 1110 by domains 1112 returned by search executed via the search engines. The list 1110 can provide parameters associated with the domains. As an example, the list 1110 can include a rank parameter 1114 for each domain based on where the domain falls in the list of search results from the search engine(s) and can include a domain type 1114 (e.g., official/authorized or unofficial/pirate). As another example, the graphical user interface can include an overall rank delta by search engine which can be provided over a time period. This can allow a user to determine which search engines are more likely to return pirate domains higher in the list of results and/or which search engines are more likely to return official domains lower in the list of results and can illustrate a cumulative effect across the various search engines. As another example, the graphical user interface 1100 can include graph 1130 that illustrates a rank comparison of official/authorized domains 1134 and unofficial/pirate domains 1136 for various search engines 1132, where the difference between the unofficial domain rank and the official domain rank can be the rank delta (unofficial rank−official rank=rank delta).

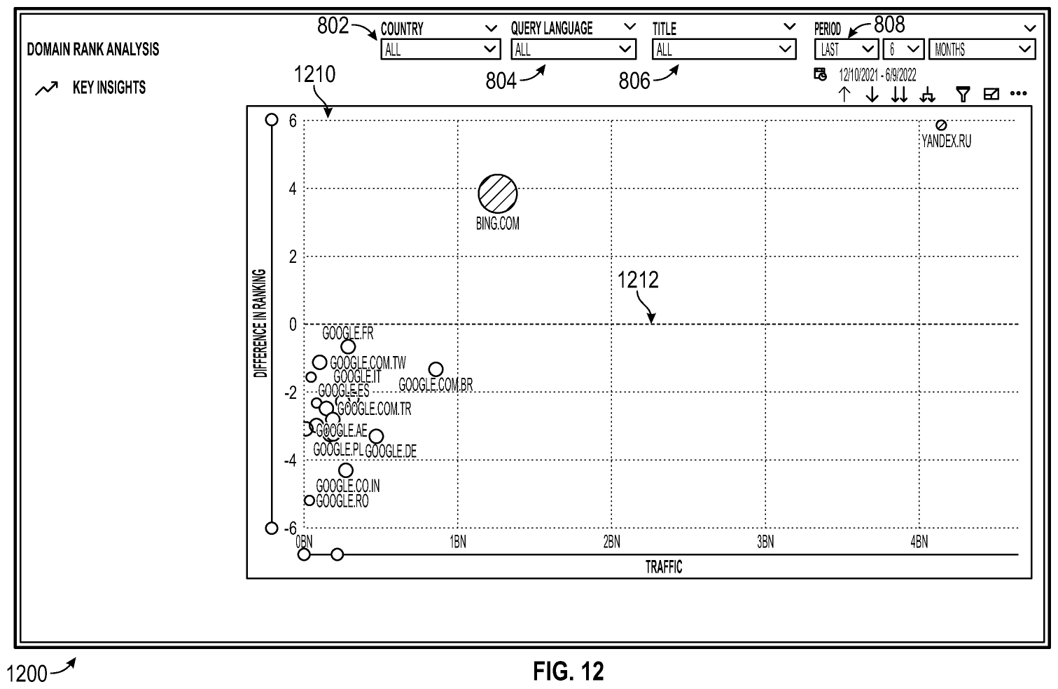

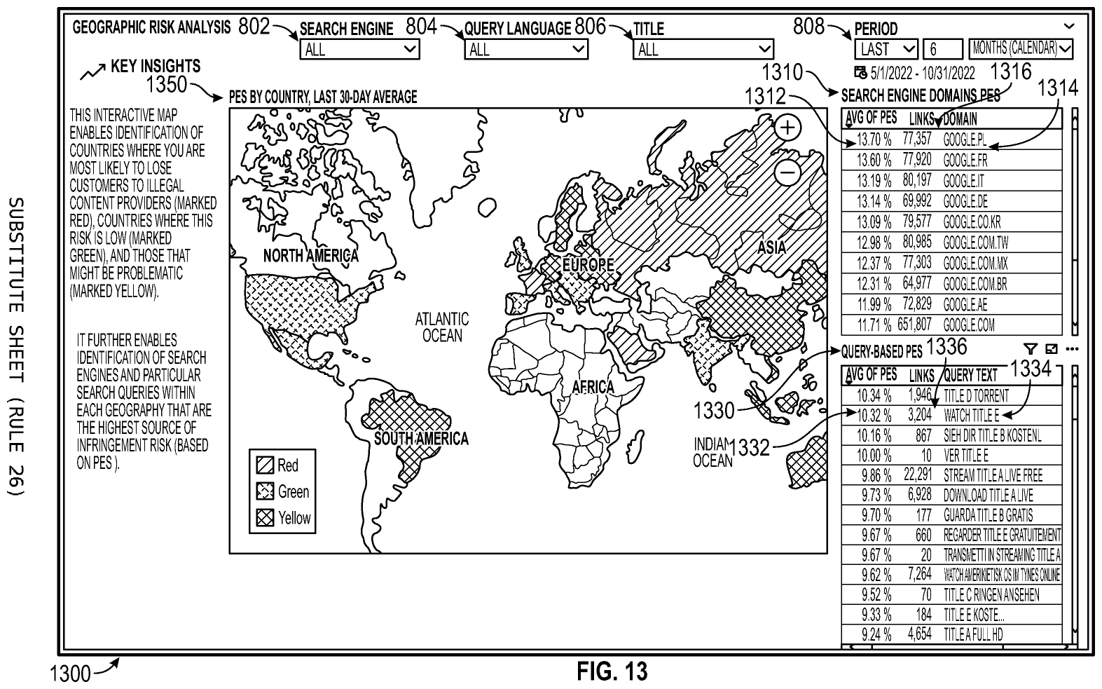

FIG. 12 is another graphical user interface 1200 that illustrates a domain rank analysis based on Internet traffic to the search engines in accordance with embodiments of the present disclosure. The graphical user interface 1200 allows a user to filter the queries to provide an interactive presentation of various parameters associated with the search queries. As an example, the graphical user interface 1200 includes the country filter 802, the language filter 804, the title filter 806, and the time period filter 808.

As shown in FIG. 12, and as a non-limiting example, the graphical user interface 1200 can include a graph 1210 that illustrates an average rank delta for search engines as a function of the Internet traffic to the search engines. The traffic to the search engines can be related to the rank delta and to the number of pirate links encountered in search results from the search engines. The rank delta can measure the difference between the average search result ranks of official and pirate domains in search results, as observed by local consumers. A negative average rank delta (below the line 1212) indicates that official domains are on average ranking higher than unofficial/pirate domains on a given search engine. The graph 1210 can be used to assist users in a two-fold strategy for combatting piracy: (1) delisting of pirate results in order to decrease overall search ranks pirate domains; and (2) optimizing official results in order to increase overall search ranks in official domains.

FIG. 13 is a graphical user interface 1300 that illustrates a geographic risk analysis that can be performed in accordance with embodiments of the present disclosure. The graphical user interface 1300 allows a user to filter the queries to provide an interactive presentation of various parameters associated with the search queries. As an example, the graphical user interface 1300 includes the country filter 802, the language filter 804, the title filter 806, and the time period filter 808.

As shown in FIG. 13, and as a non-limiting example, the graphical user interface 1300 can include one or more visualizations of the geographic risk analysis. As one example, the graphical user interface 1300 can include a list 1310 of the average PES 1312 for search engine/domains 1314 by which the search queries were executed. The list 1310 can provide parameters associated with the search engines/domain. As an example, the list 1310 can include a quantity of links 1316 for each search engine/domain. As another example, the graphical user interface 1300 can include a list 1330 of the average PES 1332 for the search query text 1334 for the executed queries. The list 1330 can include a quantity of links 1336 for each query text. As another example, the graphical user interface 1300 can include an interactive geographic map 1350 including countries and/or regions of the world that enables users to quickly identify countries or regions where content providers are most likely to lose customers to unauthorized content providers distributing pirated content. For example, the interactive geographic map 1350 can be color coded to indicate the occurrence of piracy for specific content and titles, where the color “red” can identify countries where users are most likely to lose customers to illegal content providers (pirates), green identifies countries where the risk of losing customers to piracy is low, and yellow identifies countries that are relatively in between countries with a high likelihood and a low likelihood of losing customers to piracy. The interactive map 1350 further provides users with the ability to identify which search engines/domains and/or particular query text correspond to the highest to lowest source of pirating risk within each country or region based on PES.

While FIGS. 8-13 illustrate example graphical user interfaces, graphical representations, parameters, and data, embodiments of the system 100 can include different graphical user interfaces that include different graphical representations, parameters, and data.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

The foregoing description of the specific embodiments of the subject matter disclosed herein has been presented for purposes of illustration and description and is not intended to limit the scope of the subject matter set forth herein. It is fully contemplated that other various embodiments, modifications and applications will become apparent to those of ordinary skill in the art from the foregoing description and accompanying drawings. Thus, such other embodiments, modifications, and applications are intended to fall within the scope of the following appended claims. Further, those of ordinary skill in the art will appreciate that the embodiments, modifications, and applications that have been described herein are in the context of particular environment, and the subject matter set forth herein is not limited thereto, but can be beneficially applied in any number of other manners, environments and purposes. Accordingly, the claims set forth below should be construed in view of the full breadth and spirit of the novel features and techniques as disclosed herein.

1. A system for pirated content detection, analysis, and remediation in a networked environment, the system comprising:
one or more computer-readable media storing instructions for detecting, analyzing, and remediating pirated content accessible via a network;
a processor configured to execute the instructions to:
generate a query template that includes parameters based on instances of a title associated with content to be searched and keywords;
generate sets of country-specific localized queries based on the query template;
transmit the set of country specific queries to proxy servers located in one or more countries associated with the sets of country-specific servers to execute the queries in search engine mirror sites in the countries; and
determine whether hyperlinks in search results corresponding to execution of the sets of country-specific queries provide access to pirated content.

2. The system of claim 1, where the processor is configured to initiate delisting of the search results that are determined to provide access to the pirated content.

3. The system of claim 1, wherein the processor is configured to generate the set of country-specific localized queries by generating at least one of a combination or permutations of the parameters in the query template.

4. The system of claim 1, wherein the processor is configured to generate the sets of country-specific localized queries by translating the keywords in the query template into at least one language spoken in each of the countries.

5. The system of claim 1, wherein the processor is configured to generate the sets of country-specific localized queries by replacing instances of the title in the query template with an official launch title in at least one language spoken in each of the countries.

6. The system of claim 1, wherein the processor is configured to:
generate a piracy exposure score for the content based on the search results and click-through rates for the search results.

7. The system of claim 1, wherein the processor is further configured to:
determine an overall search volume for the title associated with the content in the one or more countries and in at least one language spoken in each of the one or more countries; and
determine a piracy search volume for the title associated with the content in the one or more countries and in at least one language spoken in each of the one or more countries.

8. The system of claim 7, wherein the processor is further configured to:
combine the piracy exposure score with at least one of the overall search volume or the piracy search volume for the title associated with the content; and
determines, for each of the one or more countries and the at least one language, an expected piracy volume corresponding to a probability that hyperlinks in search results providing access to pirated content are selected.

9. The system of claim 7, wherein the processor is further configured to:
determine an official rank associated with official domains in the search results providing access to authorized content associated with the title;
determine a piracy rank associated with unofficial domains in the search results providing access to pirated content associated with the title; and
determine a difference between the piracy rank and the official rank to provide an indication of a threat of piracy by at least one of country, language, title, or search engine site.

10. The system of claim 1, wherein the processor is configured to:
generate database records corresponding to the results; and
associate an infringing or pirated label with the results that provide access to pirated content.

11. The system of claim 1, wherein the processor is configured to:
translate the keywords into corresponding primary and secondary languages spoken in the countries.

12. A method for detecting, analyzing, and remediating pirated content accessible via a network, the method comprising:
generating a query template that includes instance of a title associated with content to be searched and keywords;
generating sets of country-specific queries based on the query template;
transmitting the set of country-specific localized queries to proxy servers located in countries associated with the sets of country-specific localized servers to execute the country-specific localized queries in search engine mirror sites in the countries; and
determining whether hyperlinks in search results corresponding to execution of the sets of country-specific queries provide access to pirated content.

13. The method of claim 12, further comprising:
initiating delisting of the search results that provide access to the pirated content.

14. The method of claim 12, wherein generating the set of country-specific localized queries comprises generating at least one of combination or permutations of the parameters in the query template.

15. The method of claim 12, wherein generating the sets of country-specific localized queries comprises translating the keywords in the query template into at least one language spoken in each of the countries.

16. The method of claim 12, wherein generating the sets of country-specific localized queries comprises replacing instances of the title in the query template with an official launch title in at least one language spoken in each of the countries.

17. The method of claim 12, further comprising:
generating a piracy exposure score for the content based on the search results and click-through rates for the search results.

18. The method of claim 17, further comprising:
determining an overall search volume for the title associated with the content in the one or more countries and in at least one language spoken in each of the one or more countries; and
determining a piracy search volume for the title associated with the content in the one or more countries and in at least one language spoken in each of the one or more countries.

19. The method of claim 18, further comprising:
combining the piracy exposure score with at least one of the overall search volume or the piracy search volume for the title associated with the content; and
determining, for each of the one or more countries and the at least one language, an expected piracy volume corresponding to a probability that hyperlinks in search results providing access to pirated content are selected.

20-22. (canceled)

23. A non-transitory computer-readable medium storing instructions for detecting, analyzing, and remediating pirated content accessible via a network that when executed by a processor causes the processor to:
generate a query template that includes instance of a title associated with content to be searched and keywords;
generate sets of country-specific localized queries based on the query template;
transmit the set of country-specific localized queries to proxy servers located in countries associated with the sets of country-specific servers to execute the queries in search engine mirror sites in the countries; and
determine whether hyperlinks in search results corresponding to execution of the sets of country-specific queries provide access to pirated content.

24-29. (canceled)
